(19) United States
(12) Patent Application Publication
(10) Pub. No.: US 2025/0060484 A1
(43) Pub. Date: Feb. 20, 2025

(54) MATERIAL IMAGING SYSTEM AND METHOD

(71) Applicant: ESCO GROUP LLC, PORTLAND, OR (US)

(72) Inventor: Timothy A. McKinley, Albany, OR (US)

(73) Assignee: ESCO Group LLLC, Portland, OR (US)

(21) Appl. No.: 18/756,950

(22) Filed: Jun. 27, 2024

Related U.S. Application Data
(62) Division of application No. 18/516,916, filed on Nov. 21, 2023.
(60) Provisional application No. 63/464,917, filed on May 8, 2023.

(51) Int. Cl. G01S 17/89; E02F 9/26; E21B 49/00; G01S 7/481; G01S 7/484; G08B 5/36

(52) U.S. Cl. CPC G01S 17/89; E02F 9/262; E21B 49/005; G01S 7/4813; G01S 7/4814; G01S 7/484; G08B 5/36

(57) ABSTRACT

A spectral light detection and ranging (Lidar) imaging system for earthen material, including a spectral Lidar unit directed towards a target location and a controller communicatively couped to the spectral Lidar unit. The spectral Lidar unit is operable to image the target location by emitting pulses of light towards the target location and capturing spectral and spatial data from a return of the light. The system also includes a controller communicative coupled to the spectral Lidar unit to use the spectral data to determine a desirability of material and generate a direction for further processing based on the desirability of the material.

### RELATED APPLICATIONS

This application is a divisional of pending application Ser. No. 18/516,916, filed Nov. 21, 2023, which claims priority benefits to U.S. Provisional Patent Application No. 63/464,917, filed May 8, 2023, and both entitled “Material Imaging System and Method,” and are incorporated herein by reference in their entirety.

### FIELD OF THE INVENTION

The specification relates generally to imaging, and, more specifically, to imaging using a spectral Lidar unit.

### BACKGROUND OF THE INVENTION

In a mining operation, valuable ore material is commonly extracted alongside waste material. Much of the waste material is hauled away from the extraction point and processed along with the valuable ore material. For example, the waste material may be crushed into finer particles, and processed through beneficiation stages. After one or more processing stages, the waste material is commonly separated from the valuable ore material, and may be discarded. Processing waste material that is ultimately discarded may consume energy or water unnecessarily or cause premature wear to processing equipment.

### SUMMARY OF THE INVENTION

The following summary is intended to introduce the reader to various aspects of the applicant's teaching, but not to define any invention.

In one example, a spectral light detection and ranging (Lidar) imaging system for earthen material includes: a spectral Lidar unit directed towards a target location and operable to image the target location containing the earthen material by emitting pulses of light at a plurality of wavelengths from a light source and capturing spatial data and spectral data at the plurality of wavelengths, the spectral data including an intensity of a return of the light from the target location for each of a plurality of wavelength bands; and a controller communicatively coupled to the spectral Lidar unit to control operations of the spectral Lidar unit and receive data from the spectral Lidar unit, the controller including at least one processor and at least one data storage device communicatively coupled to the at least one processor and having stored thereon emission characteristics of the light and computer-executable instructions for operating the at least one processor to: direct the spectral Lidar unit to image earthen material at the target location to generate spatial data and spectral data of the earthen material at each of the plurality of wavelengths, receive the spatial data and spectral data of the earthen material, determine a reflectance at the plurality of wavelengths of the earthen material using the spectral data of the earthen material and the emission characteristics of the light, characterize the earthen material based on the reflectance, determine a desirability of the earthen material based on the reflectance, and generate an output signal, the output signal indicating a first direction for the earthen material if the desirability of the earthen material is at or above a predetermined threshold level and a second direction different from the first direction if the desirability of the earthen material is below the predetermined threshold level.

In another example, a spectral light detection and ranging (Lidar) imaging system for earthen material includes: a spectral Lidar unit directed towards a target location and operable to image the target location containing earthen material by emitting pulses of light at a plurality of wavelengths from a light source and capturing spatial data and spectral data at the plurality of wavelengths, the spectral data including an intensity of a return of the light from the target location for each of a plurality of wavelength bands; an alert device; and a controller communicatively coupled to the spectral Lidar unit and the alert device to control operations of the spectral Lidar unit and alert device and to receive data from the spectral Lidar unit, the controller including at least one processor and at least one data storage device communicatively coupled to the at least one processor and having stored thereon emission characteristics of the light and computer-executable instructions for operating the at least one processor to: direct the spectral Lidar unit to image earthen material at the target location to generate spatial data and spectral data of the earthen material at each of the plurality of wavelengths, receive the spatial data and spectral data of the earthen material, determine a reflectance at the plurality of wavelengths of the earthen material using the spectral data of the earthen material and the emission characteristics of the light, determine a desirability of the earthen material based on the reflectance, generate an output signal, the output signal indicating a first direction for the earthen material if the desirability of the earthen material is at or above a predetermined threshold level and a second direction different from the first direction if the desirability of the earthen material is below the predetermined threshold level, and provide the output signal to the alert device, and wherein the alert device is operable to provide an alert to an output device based on the output signal, the alert indicating the first direction or the second direction.

In a further example, a spectral light detection and ranging (Lidar) imaging method for earthen material includes: emitting light towards a target location containing earthen material; capturing spatial data and spectral data at a plurality of wavelengths, the spectral data including an intensity of a return of the light from the target location for each of a plurality of wavelength bands; determining a reflectance of the earthen material using the spectral data of the earthen material and emission characteristics of the light; determining a desirability of the earthen material based on the reflectance; generating an alert indicating a first direction for the earthen material if the desirability of the earthen material is at or above a predetermined threshold level and indicating a second direction different from the first direction if the desirability of the earthen material is below the predetermined threshold level; and presenting the alert to an output device for a human operator or automated earth moving equipment to interact with.

In a further example, a spectral light detection and ranging (Lidar) imaging system for earthen material includes: a spectral Lidar unit directed towards a target location and operable to image the target location containing the earthen material by emitting pulses of light at a plurality of wavelengths from a light source and capturing spatial data and spectral data at the plurality of wavelengths, the spectral data including an intensity of a return of the light from the target location for each of a plurality of wavelength bands; and a controller communicatively coupled to the spectral Lidar unit to control operations of the spectral Lidar unit and receive data from the spectral Lidar unit, the controller including at least one processor and at least one data storage device communicatively coupled to the at least one processor and having stored thereon emission characteristics of the light, a survey model, and computer-executable instructions for operating the at least one processor to: direct the spectral Lidar unit to image earthen material at the target location to generate spatial data and spectral data of the earthen material at each of the plurality of wavelengths, receive the spatial data and spectral data of the earthen material, determine a reflectance at the plurality of wavelengths of the earthen material using the spectral data of the earthen material and the emission characteristics of the light, characterize the earthen material based on the reflectance, determine a desirability of the earthen material based on the reflectance, and update a survey model based on the desirability of the earthen material.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of a first spectral Lidar imaging system;

FIG. 2 is a perspective view of a second spectral Lidar imaging system;

FIG. 3 is a perspective view of a third spectral Lidar imaging system;

FIG. 4 is a perspective view of a fourth spectral Lidar imaging system; and,

FIG. 5 is a flow chart of an imaging method.

### DETAILED DESCRIPTION

The present disclosure is directed to applications in which spectral information about a material is acquired using a spectral light detection and ranging (Lidar) unit. The spectral Lidar unit may acquire spectral data by generating pulses of light and capturing an intensity of a return of the light for a plurality of wavelength bands of interest (e.g. any plurality within 1900-2500 nm) and simultaneously determining the range and location from the material to create a 3D point cloud(s). The spectral data may be used to identify the material and determine a desirability of the material from a container filed with earthen material. Earthen material includes all material that may be loaded within a load container at a mine site, including foreign objects or non-desirable material, such as tramp metal or clay that may erroneously get picked up by and/or loaded into a load container. Identifying a material may include directly identifying a particular element or elements found in the material or, also or alternatively, determining one or more material properties for an indirect measurement of a particular element (e.g., illite crystallinity index, lithology, mineral alteration, porosity, moisture content, and the like). Identifying the valuable material may include applying spatial information of the material and emission characteristics of the spectral Lidar unit to determine a reflectance of the material and comparing the reflectance of the material to pre-determined reflectance information for known materials (e.g., a library of information or a machine learned model). The desirability of the material determined may be used to direct the material (or a container thereof). The desirability of the material may be used to select one of a plurality of directions (e.g., sorting the material). The plurality of directions may be, e.g., two directions, three directions, or more than three directions. For example, selecting a direction may include directing highly-desirable material to a first area for further processing and directing undesirable or lowly-desirable material to a second area for holding. In a further example, selecting a direction may include directing highly-desirable material to a first area, directing undesirable or lowly-desirable material to a second area, and directing material having a medium desirability level (e.g., between two predetermined thresholds) to a third location. In further examples, more than three locations and/or directions may be included, such as for more than three grades (e.g., separated by more than two thresholds). In some examples, the data generated by the spectral Lidar unit includes spatial information, such as material bulk or individual size, material bulk or individual shape, and/or position information, which may also be used for determining a desirability of a quantity of material as a whole, or may be used to determine a desirability for each of a plurality of subsets or parts of the material (e.g., a first desirability for a first part of a pile of material and a second, different desirability for a second part of the pile of material, so that the parts can be treated separately). Additionally, the desirability of the material may be determined through the identification of a particular material that indicates an unwanted constituent within the container even though the rest of the material in the container could be desirable. An example of the unwanted constituent could be a steel or metal anomaly, tramp metal, or clay.

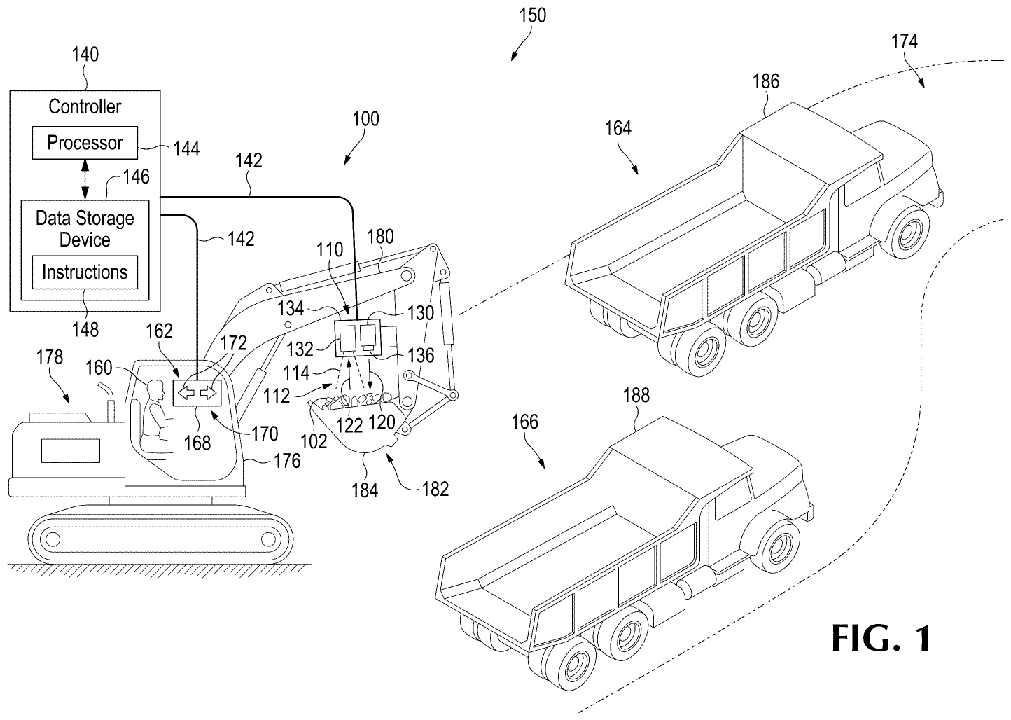

As exemplified in FIG. 1, an imaging system 100 is provided to acquire spectral information about material 102. The imaging system 100 is a spectral light detection and ranging (Lidar) imaging system, and includes a spectral Lidar unit 110.

The spectral Lidar unit 110 is directed towards a target location 112. As exemplified in FIG. 1, the target location 112 may be zoned for at least a portion of a tool 182 of the mining machine 178. For example, a container or bucket 184 of a back hoe excavator. The spectral Lidar unit 110 may be mounted to the mining machine 178, such as on a boom or stick 180 of the excavator. The spectral Lidar unit 110 may be directed towards the bucket 184. The target location 112 being at least a portion of an opening of the bucket 184. The spectral Lidar unit 110 may be fixedly mounted or moveably mounted (e.g., to be moved between positions directed in different directions, such as for viewing and acquiring spectral data of material in the bucket or a work surface as described elsewhere herein). In some examples, the spectral Lidar unit 110 may be mounted to the bucket 184 or in fixed relation to the bucket 184 (e.g., so that the unit is directed into the top of the bucket regardless of the position of the bucket relative to the arm, boom or main body of the mining machine).

The target location 112 is in a field of view 114 of the spectral Lidar unit 110. The spectral Lidar unit 110 is operable to image the target location 112 by emitting pulses of light 120 towards the target location 112 and capturing spatial and spectral data from the target location. While a single spectral Lidar unit 110 is described, in some examples the imaging system 100 may include a plurality of spectral Lidar units 110 imaging a common target location or imaging a plurality of target locations.

The spectral Lidar unit 110 includes a light source 130 capable of emitting light at each of a plurality of wavelengths The plurality of wavelengths may include only specific wavelengths of interest to be used. In some examples, only the wavelengths of the light 120 that is used to illuminate the material 102 are generated (i.e., rather than generating further wavelengths and then filtering the further wavelengths out before using the light to illuminate the material), and using these specific wavelengths may allow for reduced waste energy in generating light that is not needed. For example, the infrared wavelengths from 2100-2500 nm could be used to identify Copper within earthen material located in a load container in the target location. The wavelengths of the light may be selected based on the application (e.g., materials to be identified and/or other operational requirements). In some examples, the wavelengths of the light 120 are outside the visible spectrum (e.g., to avoid damaging human eyes or distracting human operators). In some examples, the plurality of wavelengths is a few predetermined wavelengths (e.g., less than 15, less than 10, or less than 5 wavelengths), such as due to filtering of generated wavelengths or by generating only the predetermined wavelengths. In other examples, the specific wavelengths of light are not sequential, e.g., 1900-2500 and 2800-2900 nm are used.

Spectral data includes an intensity of a return 122 of the light 120 from the target location 112 for each of a plurality of wavelength bands (e.g., bands that include the wavelengths of the light). The bands (e.g., infrared wavelengths) may be selected based on the application, such as selected to correspond to bands in which a material or composition of interest would exhibit a characteristic feature or characteristic features (e.g., a characteristic signature), e.g., emission or absorption lines.

In some examples, imaging using the spectral Lidar unit 110 includes capturing spatial position information. Spatial data of the earthen material captured by the spectral Lidar unit may include associated spatial position information of the earthen material 102. The spatial data from the spectral Lidar unit may be a three-dimensional point cloud (e.g., a high-density 3D point cloud) of the material 102 with spectral information for the individual plot points.

The light source 130 generates intense light 120, to generate an intense return. The focused nature of the light may enable the return to be strong enough at typical distances for proper functioning of the spectral Lidar unit 110. The intensity of the return 122 affects the accuracy of the spectral Lidar imaging system 100. As discussed elsewhere herein, in some examples the spectral Lidar unit 110 is positioned far enough away from the material 102 to protect the unit 110 from premature wear and the intensity and lensing of the light 120 is selected accordingly. In some examples, the intensity needs to be sufficiently greater than any inherent or situational noise (e.g., due to varying and uncontrolled radiation, such as solar radiation) for a proper analysis to be completed. The spectral Lidar unit 110 may be selected and/or positioned such that the intensity of the return 122 of the light 120 is at least a predetermined multiple of expected inherent or situational noise. For example, the intensity of the return 122 may be at least a predetermined multiple of an intensity of reflected solar radiation from the target location received at the spectral Lidar unit 110. The predetermined multiple may be at least 2 times, at least 5 times, or at least an order of magnitude. The intensity of the return 122 of the light 120 may be determined by filtering out any inherent or situational noise (e.g., due to varying and uncontrolled radiation, such as solar radiation). Using pulses of collimated light may reduce the illumination requirements of the light.

The spectral Lidar unit 110 may include at least one sensor 132 operable to capture the spatial and spectral data from the target location 112. The field of view 114 may be a field of view of the sensor 132. The light source 130 and the sensor 132 are provided together in a common unit 110, and may be, e.g., secured to one another or secured to a common frame. In some examples, the spectral Lidar unit 110 includes a common housing 134 containing the laser source 130 and the sensor 132. In some examples, the housing 134 may be a closed housing (e.g., waterproof or dust proof).

The spectral Lidar unit 110 may be mounted at one of many locations throughout a processing facility (e.g., a mining extraction and processing chain). The spectral Lidar unit 110 may be moved between locations (e.g., portable) and/or multiple units may be used with one or more at each of a plurality of locations. The customization in the emission wavelengths permits differing analysis to be conducted at each location, if desired. This can aid in a hierarchical sorting strategy that focuses on identification of particular ore, waste (including tramp metal), or both throughout the mining operational progression, increasing the sorting strategy for the equipment/processing downstream and the volume of sortable material.

While a single light source 130 and a single sensor 132 are described, in some examples the spectral Lidar unit 110 may include a plurality of light sources and/or a plurality of sensors. For example, the spectral Lidar unit may include a plurality of laser sources operable to emit light at the same or different wavelengths as one another and/or a plurality of sensors operable to capture intensity and spatial data for the same or different wavelength bands as one another.

In some examples, the light source 130 is a laser source. In some examples, the light source 130 is a supercontinuum laser source. The supercontinuum laser source can generate a wide range of intense illumination wavelengths or wavelength bands. In some examples, the light source 130 includes a filter and/or lens 136 arranged to selectively filter out all but select wavelengths, e.g., all but the plurality of wavelengths of the light 120. Also, or alternatively, the light source 130 is operable to generate only the plurality of wavelengths of the light 120.

In some examples, the sensor 132 is a spectral imager. In some examples, the spectral imager is a multi- or hyper-spectral camera. A hyperspectral camera captures intensity information for many wavelength bands of illumination for each individual pixel from the hyperspectral camera's field of view (e.g., 37 or more spectral bands). The hyperspectral camera may also capture intensity information for a lesser number of discrete bands. The bands of a hyperspectral camera may be for consecutive wavelength ranges (i.e., not separated by unsampled portions of the spectrum) or non-consecutive wavelength ranges (i.e., separated by unsampled portions of the spectrum).

The spectral Lidar imaging system 100 may also include a controller 140. The controller 140 is communicatively coupled to the spectral Lidar unit 110 (e.g., via a wired and/or wireless network 142) to control operations of the spectral Lidar unit 110 and to receive imaging (spectral and spatial) data from the spectral Lidar unit 110. In some examples, the controller 140 includes at least one processor 144 and at least one data storage device 146. The controller 140, or a component thereof (e.g., one or more processor 144 and/or one or more data storage device 146), may be integrated into the spectral Lidar unit 110 (e.g., within the housing 134). The controller 140 may be distributed or a single machine. The controller 140 may be virtual or real. The controller 140 may be remote or local.

The at least one data storage device 146 stores a set of computer-executable instructions 148 for operating the at least one processor 144. The at least one data storage device 146 may also store further information (e.g., emission characteristics of the light source 130, a predetermined threshold amount for any given valuable material, one or more schedule, or a library of pre-determined reflectance information).

The set of instructions 148 include instructions to direct the spectral Lidar unit 110 to image the material 102 at the target location 112 to acquire spatial and spectral data of the material 102. Acquiring spectral data includes emitting the light 120 at the target location 112 and capturing an intensity of the return 122 of the emitted light 120 from the target location 112. Acquiring spatial data may include measuring the time between emitting a pulse of light and receiving a return, to estimate the distance and/or orientation to the material from which the light returns.

The spectral Lidar unit 110 may be operated in any suitable way to capture the spectral and spatial data, such as in accordance with a predetermined schedule or in response to a sensed acquisition criteria (e.g., sensing that the material 102 is at the target location 112). Spectral and spatial data may be captured only when the material 102 is at the target location 112 and/or may be processed after capture to isolate the valuable material 102.

The set of instructions 148 may include instructions to receive the spectral and spatial data of the material 102 from the spectral Lidar unit 110 and determine a reflectance of the material 102 using the spectral data. The reflectance of the material 102 may be the proportion of incident light/illumination that is reflected. Determining the reflectance of the material 102 using the spectral data may include applying predetermined spatial characteristics (e.g., how far the unit is from the material) and emission characteristics (e.g., how intense the emitted light is) of the spectral Lidar unit 110 to determine the reflectance from the spectral data. In some examples, determining the reflectance may also include estimating and/or measuring situational noise (e.g., due to varying and uncontrolled radiation, such as solar radiation). In some examples, the situational noise is negligible due to the intensity of the light. In other examples, the situational noise can be filtered out from the spectral Lidar signal.

The reflectance of the earthen material 102 may be used to characterize the material and determine a desirability of the earthen material 102. The reason the earthen material is considered desirable or not desirable may be selected based on the application. The desirability may be based on an estimated amount of valuable material in the earthen material, an estimated amount of non-valuable material in the earthen material, market prices for one or more component materials of the desirable material, estimated processing costs for extracting the valuable material from the rest of the earthen material (e.g., whether the costs will be high due to the presence of large quantities of a particular non-valuable material such as clay, which may be, e.g., difficult to separate), or if a deleterious constituent is present (e.g. steel or iron anomaly, tramp metal, or clay). The set of instructions 148 may include instructions to determine an estimate of a total desirability of the earthen material within the loaded container. Determining a desirability of the earthen material includes comparing the reflectance of the earthen material to pre-determined reflectance information for known materials (e.g., known valuable materials) to determine a composition of the earthen material 102, and may include aggregating all found valuable material within the loaded container to determine a desirability of to the earthen material 102. Analysis may be conducting during the filling or emptying of the earthen material 102 into or out of the loaded container (e.g., imaging a stream of material as the material is falling into or out of the container), or based on just the top surface of the earthen material 102 when the loaded container is already full (e.g., imaging a top surface of a pile of material). The pre-determined reflectance information may be stored as, e.g., a library of information or a machine learned model. The assigned desirability may be based on, e.g., a percentage of the material that is expected to be a pre-determined valuable material (e.g., copper or gold). A desirability determination may be based on whether (e.g., a binary determination, such as valuable or not valuable) or to what degree the pre-determined valuable material is detected. A desirability determination may be based on whether or to what degree one or more proxy materials indicative of the pre-determined valuable material are detected.

The desirability of the earthen material 102 within the container in the field of view 114 may be used to determine whether the material is worth further processing or stockpiling for potential processing at a later time. Determining whether the material is worth further processing may depend on, e.g., the market value of the pre-determined desirable material, the current cost of processing inputs (e.g., energy, fuel, and/or water), or the availability of processing equipment (e.g., only using higher-valued materials if processing equipment is operating at or near capacity).

The desirability of the earthen material may be used to provide direction or actionable steps for the material within a facility 150. The direction may be a physical direction (e.g., a path or vector through space) or a processing instruction (e.g., changing a parameter or the settings of a stage of the facility 150 at which the material will be received). High-amounts of valuable material may result in a first direction, such as moving the material along a path to a further processing stage or adjusting the settings of the further processing stage. Low-amounts of valuable material may result in a second, different direction, such as moving the material off of the path to a holding stage, a separate processing stage, or idling a function of a further processing stage (e.g., adjusting processing parameters to accommodate the low yield). Medium-amounts of valuable material may result in a third, different direction, such as moving the material off the path to another holding stage, a separate processing stage, or altering the function of a further processing stage. Controllable parameters may include the mix of earthen materials processed together, grinding and regrind rates of a grinding mill or finish grinding mill, proportioning amounts of additives (e.g., clay, sand, or chemicals) added to the material during processing, how long the material is kept at a particular processing station (e.g., a grinding mill), a temperature to which the material is preheated before processing or during processing. The parameters may be automatically controlled or manually set. For example, an amount of water added to (e.g., dilution water added to a mill, such as sprayed onto crushing rollers) or removed from the earthen material (e.g., during a dewatering process) may be adjusted, e.g., to increase clumping of earthen material, improve wear or equipment performance, reduce handling costs, or avoid excessive dust production.

The set of instructions 148 may include instructions to generate an output signal based on the desirability of the material 102. The output signal may be based on a comparison of the desirability of the material 102 to a predetermined threshold level (e.g., a customized threshold based on whether the material is worth further processing or storing). The threshold may constantly be updating as per a machine learned process. The output signal may indicate a first direction for the material 102 if the assigned desirability is at or above the predetermined threshold level, a second, different direction for the material 102 if the assigned desirability is below the predetermined threshold level but above another predetermined threshold level, and a third, different direction for the material 102 if the assigned desirability is below both predetermined threshold levels.

The computer-executable instructions 148 may include instructions for operating the at least one processor 144 to generate an output signal for each of a plurality of subsets of a collection of earthen material 102 that is imaged, such as an output signal for each of a plurality of spatially discrete subsets. For example, groups of spatial points can be analyzed separately. In some examples, the system 100 identifies subsets that are easily separable from one another, such as different bodies or spatially-grouped bodies, and generates a separate output signal for each of the separable subsets. For example, at a given stage the system may make a single determination for a single body (e.g., a rock), such as by aggregating determinations for different points of a single body into a single determination for the body as a whole. If separate determinations are made for separate parts, the rock would need to be broken apart to take action on the determinations. In other examples a plurality of determinations for different points on a single body are stored for use in a downstream stage at which the single body may have been broken apart. It will be appreciated that a single body may be broken up at a subsequent stage, after which a discrete determination could be generated for each of the newly-separated parts or spatially-grouped subsets of the newly-separated parts, or the previously-acquired determinations may be applied.

In some examples, the system 100 is operable to determine particle size and use the particle size in determining a valuation for individual particles or fragments (e.g., large or small rocks) within a collection of earthen material 102 or a subset thereof. Individual rock fragmentation can be conducted. This combination of particle size, shape, and/or spectral information in the data generated by the spectral Lidar unit can be used to enhance the determination and/or valuation of a given collection of earthen material or subset thereof.

The output signals may be used to identify which subsets are valuable enough for further processing, rather than making the determination for the entire collection of earthen material as a whole. For example, the at least one processor 144 may generate a first output signal associated with a first subset of the earthen material and a second output signal associated with a second subset of the earthen material, the first subset at a first spatial position and the second subset at a second spatial position different from the first spatial position. In another example, a foreign object or tramp metal may be detected, and the at least one processor may generate a different output signal or a second output signal associated with foreign object detection. For example, each of the first subset and the second subset may be a collection of bodies (e.g., rocks) or a singular body (e.g., a single rock). For example, the output signals may be used to detect a valuable singular body (e.g., a single rock) in a pile of non-valuable earthen material (e.g., a pile of rocks and/or soil), so that the valuable singular body can be separated for further processing. In some examples, the subsets of imaged material 102 are difficult to separately handle (e.g., if it is all in a single container such as a bucket of an excavator), but in other examples, the subsets may be more easily separately handled (e.g., if a sorting system can push a first half of a pile of material off of a first conveyor belt onto a second belt and then allow the second half of the pile to pass downstream on the first belt).

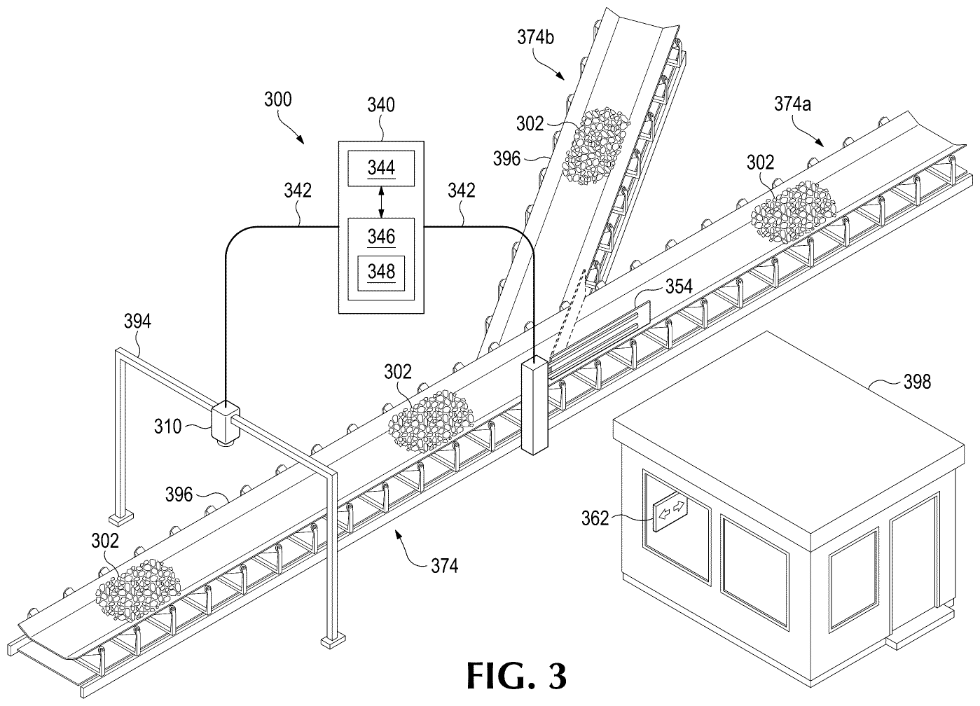

The output signal may be used to direct an alert to an output device for a human operator 160 or an automated system for the earth working equipment (e.g. a haul truck) to view or otherwise interact with an automated system. For example, the output signal may be used to direct an automated sorting system (e.g., system 354 of FIG. 3) to, e.g., divert the material out of a processing path through a processing facility, keep the material in the processing path, or modify the processing steps to which the material is subjected based on the output signal.

In some examples the output signal communicates with or is an alert device 162. The alert device 162 is communicatively coupled to the controller 140 (e.g., via the network 142) to receive the output signal. The alert device 162 is operable to generate an alert based on the output signal and provide the alert to the alert device and/or the output device for viewing by or otherwise interacting with the human operator. The alert may be, e.g., audible, visible, haptic and/or some combination of these. The alert may indicate to move the earthen material 102 to one of a plurality of deposit areas. For example, the alert or alert device may indicate to move the material towards a first area 164 (e.g., a deposit area for highly desirable material) if the output signal includes the first direction and indicating to move the material towards a second area 166 (e.g., deposit area for undesirable material) if the output signal includes a second direction. In some examples, a third or further area may be available, and the alert may direct the material to a selected area of the three or more areas. As illustrated, the operator 160 may be directed to deposit the material 102 in the bucket 184 onto a first transport 186 (e.g., a first haul truck) or onto a second transport 188 (e.g., a second haul truck or conveyor belt). The first transport 186 may be used for highly desirable material (e.g., sent to a subsequent processing stage of a processing facility) and the second transport 188 may be used for undesirable material (e.g., sent to a waste dumping area). In another example, the operator 160 may be directed to deposit the material 102 onto the ground adjacent the mining machine 178 (e.g., forming a pile of undesirable material near an excavator or forming a pile of highly desirable material near an excavator if no transport is available for that material).

The alert device 162 includes an output device 168. In a human operator example, the output device 168 may include a haptic feedback device such as a handle or seat equipped with a vibration actuator or a tilt actuator (e.g., to move the handle or seat in a spatial direction that the human operator should follow). The output device 168 may include an audible output device such as a speaker or bell. The output device 168 may include a visible output device such as a screen or light. The output device 168 may include a screen operable to display an icon or graphic (e.g., an arrow pointing in the spatial direction in which the human operator or earth moving equipment should move the material or a picture representing the area that the material should be moved to) or a textual or numerical message (e.g., the message ‘waste’ or the message ‘high grade ore’ or the message ‘medium grade ore’, or the identification of a specific haul vehicle that the earthen material is to be deposited in).

The output device 168 may include a lighting system 170. The lighting system 170 may include an output lamp 172 (e.g., an LED) or a plurality of discrete output lamps 172. The lighting system 170 may display a first illumination if the output signal indicates the first direction and a second, different illumination if the output signal indicates the second direction. For example, the first illumination may be a first color (e.g., green, indicating that the human operator should proceed with a predetermined action such as moving the material along a material transport path 174) and the second illumination may be a second color (e.g., red, indicating that the human operator should wait for further instructions). Optionally, each color is generated by the same single output lamp 172. As another example, the first illumination may be generated by switching on a first lamp of the plurality of discrete output lamps 172, and the second illumination may be generated by switching on a second lamp of the plurality of discrete output lamps. The first lamp may illuminate a first icon such as an arrow pointing left while the second lamp illuminates a second icon such as an arrow pointing right, or the first lamp may be a first color while the second lamp is a second color. In some examples, three or more discrete illuminations are available to be selected from, such as three or more colors (e.g., green, red, and yellow) or three or more discrete lights.

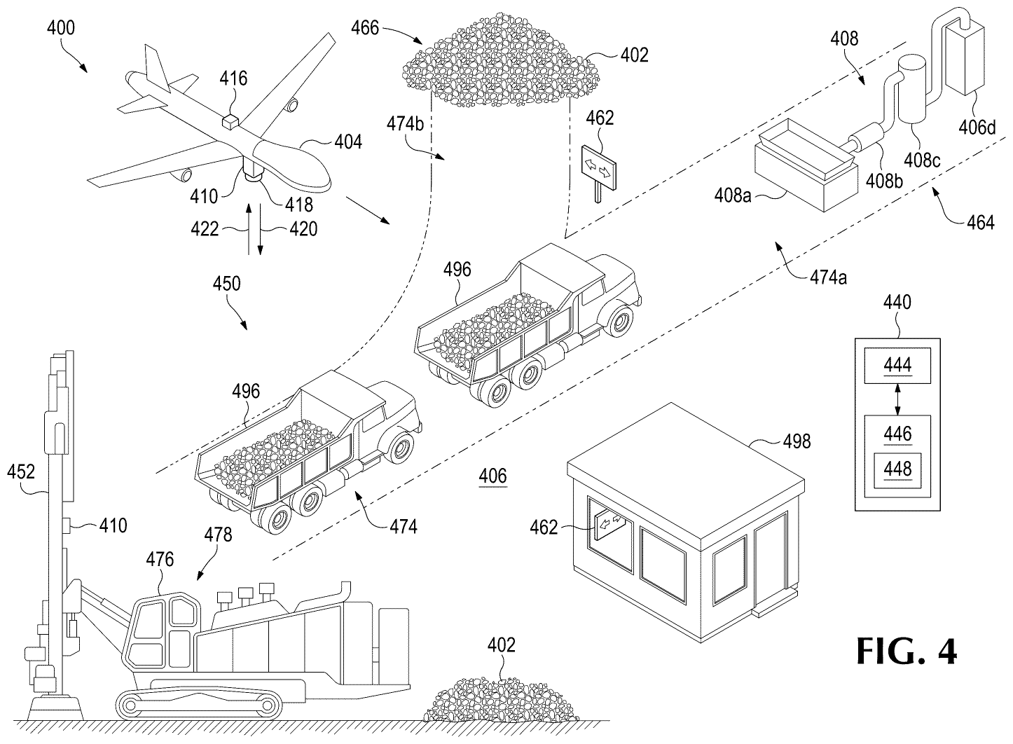

The alert device 162 may be remote from the spectral Lidar unit 110 and/or the target location 112. As exemplified in FIG. 1, the alert device 162 may be in a cab 176 of a mining machine 178, while the spectral Lidar unit 110 is outside the cab 176 (e.g., on the boom or stick 180). In other examples (e.g., FIG. 4), the alert device 462 may be further along a material transport path than the spectral Lidar unit 110 (e.g., so that the alert can direct a driver of a transport vehicle that has driven past the spectral Lidar unit 110). A single alert device 162 is described, however it will be appreciated that multiple alert devices 162 may be provided, such as an alert device for each of a plurality of human operators (e.g., if the operators are at different locations) or a plurality of alert devices for a single operator (e.g., if it is not known where the operator will be or which alert device the operator will be exposed to).

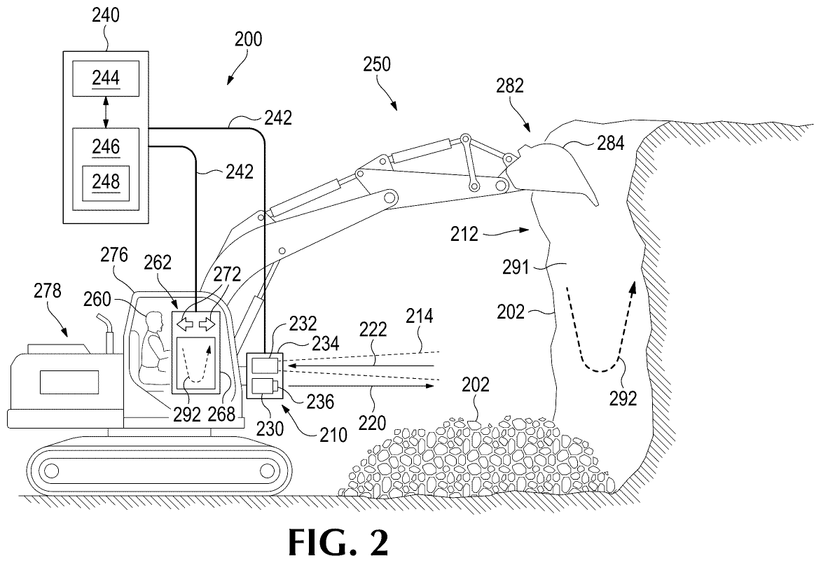

In some examples, the facility 150 may be a mining facility. The spectral Lidar imaging system 100 may be an earthen material imaging system configured to determine a desirability of earthen material (e.g., storing spectral information for one or more known valuable earthen materials) and sort the desirable material. The earthen material may have a non-uniform surface texture and may be composed of a plurality of constituents (e.g., different types or rocks and/or soils which may be formed together into a work surface such as a face 291 of a formation (FIG. 2) or piled together, e.g., on the ground, on a conveyor belt, or on the bed of a truck).

The earthen material 102 may be provided in an outdoor location, such as an outdoor excavation site of a mining facility or an outdoor processing stage (e.g., a course crushing stage, a fine crushing stage, or a sorting stage) of an excavation site. The earthen material 102 may move rapidly through the target location 112 and/or the spectral Lidar imaging system 100 may need to accommodate large equipment (e.g., haul trucks) moving the earthen material through the target location 112. The mining activity may cause variations in ambient light (e.g., due to dust stirred up by mining operations) and/or the transport of the material 102 may cause variations in ambient light (e.g., due to dust stirred up by transport vehicles).

Referring now to FIG. 2, illustrated is a spectral Lidar imaging system 200. The spectral Lidar imaging system 200 is substantially similar to the spectral Lidar imaging system 100 with the noted exceptions, and like components are indicated by like reference numbers incremented by 100.

The spectral Lidar imaging system 200 may include a spectral Lidar unit 210. The spectral Lidar unit 210 may be operable to emit light 220, and has a field of view 214. The spectral Lidar unit 210 may include at least one sensor 232 operable to capture spatial and spectral data from a return 222 from a target location 212. The field of view 214 may be a field of view of the sensor 232. A light source 230 (e.g., with an output passing through a filter or lens 236) may generate the light 220, and the light source 230 and the sensor 232 may be provided together in a common unit 210, e.g., in a common housing 234.

As exemplified in FIG. 2, the target location 212 may be adjacent to a mining machine 278. The spectral Lidar unit 210 mounted to the mining machine 278 (e.g., to the cab 276 or another portion of the main body, or on the articulating boom or linkages of the machine), and may be directed at a target location at a work surface 290 adjacent the mining machine 278. The work surface may be, e.g., a loose layer of earthen material such as material loosened by blasting, or a face 291 of a formation such as a rock face (FIG. 2).

The imaging system 200 may allow a direction to be provided to an operator 260 (e.g., in cab 276) as to what to do with a tool 282 (e.g., in real time). For example, if the tool is a bucket, the operator may be directed (e.g., via an alert device 262) as to which material to pick up (e.g., picking up undesirable material to clear space or picking up highly desirable material for processing). The alert device 262 may include an output device 268 directing the operator via a graphic or lighting system 272, such as via a path shown on a screen (e.g., a touchscreen).

The operator 260 may be directed to apply the tool at an indicated area 292. The indicated area 292 may be a general area (e.g., directing the operator to focus on scooping up material in a given area, such as material south of the excavator) or a specific path (e.g., a digging path at a mine face or through loose material). The indicated path 292 may be specific path including a start point and an end point and a specific route to take between the start point and end point (e.g., a linear route or a non-linear route). The indicated area 292 may be indicated to the operator 260 in relation to landmarks, such as showing the indicated area relative to a right side, left side, front or back of the mining machine 278 or relative to a top, bottom, or lateral edge of a face 291 of a formation or relative to one or more further features or landmarks visible to the operator. In some examples, the indicated area 292 may be indicated directly on a work surface, such as via a visible light projected on the work surface to guide the operator (e.g., a laser pointer directing operations). It will be appreciated that the indicated area 292 may be specific to a given application. The indicated area 292 may be selected to include material of a generally constant desirability and/or selected to avoid material having a desirability that is sufficiently different from other material that the tool is applied to (e.g., avoiding material that is more different than a pre-determined level). For example, an operator 260 may be directed to apply a bucket along an indicated digging path through undesirable material, avoiding highly-desirable material, so that the undesirable material is sorted by being picked up to be moved out of the way so a subsequent bucket pass can be filled with highly-desirable material.

A controller 240 controls operations and/or receives information from the spectral Lidar unit 210 (e.g., communicatively coupled via a communications network 242). In some examples, the controller 240 includes at least one processor 244 and at least one data storage device 246. The at least one data storage device 246 stores a set of computer-executable instructions 248 for operating the at least one processor 244.

Referring now to FIG. 3, illustrated is a spectral Lidar imaging system 300. The spectral Lidar imaging system 300 is substantially similar to the spectral Lidar imaging system 100 with the noted exceptions, and like components are indicated by like reference numbers incremented by 200.

The spectral Lidar imaging system 300 may include a spectral Lidar unit 310 mounted to a support structure 394. The support structure 394 may be adjacent a material movement path 374. In the illustrated example, the support structure is a gantry fixed to the ground extending over a material movement path 374 to image material loosely piled on a transport (e.g., truck or conveyor belt) that is moving along the movement path, but other configurations are possible (e.g., a L-shaped gantry). The support structure 394 may be between an excavation site and a downstream processing facility (e.g., adjacent a haul truck route upstream of a primary crusher machine of a processing facility) or may be between stages of a processing facility (e.g., adjacent a conveyor belt extending between a primary crusher and a downstream processing stage). The support structure 394 may be adjacent an excavation site, such as a land-based structure near a work surface.

The spectral Lidar unit 310 may be held at a fixed distance and position relative to the ground (e.g., relative to a work surface or transport path) when mounted to the support structure 394. In some examples, the spectral Lidar unit 310 is reorientable while mounted to the support structure 394. For example, the spectral Lidar unit 310 may be redirected while mounted to the support structure, such as redirected vertically and/or horizontally. For example, the spectral Lidar unit 310 may be mounted near a work surface and may scan across the work surface to identify a digging path.

A controller 340 controls operations and/or receives information from the spectral Lidar unit 310 (e.g., communicatively coupled via a communications network 342). In some examples, the controller 340 includes at least one processor 344 and at least one data storage device 346. The at least one data storage device 346 stores a set of computer-executable instructions 348 for operating the at least one processor 344.

The computer-executable instructions 348 include instructions for operating the at least one processor 344 to acquire spectral data of material 302 and generating the output signal. The spectral Lidar unit 310 may be positioned to image the material 302 as the material is carried along the material transport path 374 by a transport 396 (e.g., a haul truck or a conveyor belt as exemplified in FIG. 3).

An alert device may be provided at a remote location, e.g., a subsequent position along the material transport path 374 where the path splits. For example, the spectral Lidar unit 310 may be provided at a first location spaced from diverging branches 374a, 374b of the transport path 374 and the alert device may be provided at the subsequent position closer to the diverging branches (e.g., at the divergence point), such as to direct an operator of (e.g., the operator of a transport, such as the driver of a haul truck) as to which branch to take. The alert device 362 may also or alternatively be provided at a control station 398 (e.g., remote from the support structure 394) to an operator monitoring the spectral Lidar imaging system 300 from the control station 398.

Also, or alternatively, the output signal from the controller 340 may be provided to an automated system 354 to, e.g., sort or divert the material out of a processing path through a processing facility, keep the material in the processing path, or modify the processing steps to which the material is subjected based on the output signal. The automated system 354 may direct the material, such as by pushing material off of one belt and onto another as directed by the controller 340.

In some examples, discrete quantities of material 302 (e.g., discrete piles) may be spaced from one another (i.e., by spaces 303). Spacing between earthen material quantities may be required to allow the system to handle different desirability determinations for adjacent quantities of material 302.

Referring now to FIG. 4, illustrated is a spectral Lidar imaging system 400. The spectral Lidar imaging system 400 is substantially similar to the spectral Lidar imaging system 100 with the noted exceptions, and like components are indicated by like reference numbers incremented by 300.

As illustrated in FIG. 4, the spectral Lidar imaging system 400 may include a spectral Lidar unit 410 mounted to an aircraft 404. The aircraft 404 may fly over a facility 450, such as a mining facility. The spectral Lidar unit 410 may simultaneously measure spectral reflectance and distance in a plurality of locations (e.g., at least three different locations, such as locations selected from a location in a truck bed of a haul truck 496, a location on a conveyor belt between a mine and a processing facility or between stages of a processing facility, a location in a bucket of a mining machine, a location at a drilling machine (e.g., an articulated boom or linkage mine drilling machine, optionally without a dust enclosure), and a location at a holding area or on a work bench), which may be facilitated by mounting the unit on an aircraft. The spectral Lidar unit 410 is operable to generate light 420. The return 422 of the light 420 is sufficiently intense to allow the spectral Lidar unit 410 to acquire spectral data from material 402 at a ground level 406 below the aircraft 404. In some examples, the aircraft 404 is a drone or unmanned aerial vehicle (UAV).

In some examples, the system 400 may be used to identify and characterize material excavated from a drilled hole, such as during a drilling process, immediately after a drilling process, or at a later time (e.g., in a batch excavated drill hole process). In some examples, the system 400 may be used to identify and characterize material forming the walls of a drilled hole, such as by imaging a sidewall of a drilled hole. For example, a spectral Lidar unit 410 may be mounted near a drilling machine 478 (e.g., to an adjacent support or to another ground vehicle or aircraft) or mounted to the drilling machine 478 during a drilling operation performed by the mining machine, e.g., to image material as it is lifted up or to image a wall of the drilled hole after the hole is drilled. The target location imaged may be a location at which material lifted from the drilled hole is deposited or may be a down hole location at a wall of a drill hole formed by the drilling machine. For example, the drilling machine 478 may include a drill 452, and may be an articulated boom or linkage mine drilling machine, optionally a non-dust enclosure mining machine such as the Komatsu KT44™. The spectral Lidar unit 410 may be mounted to the drill 452, near the drill 452, or to another portion of the mining machine 478, such as the cab 476.

The system 400 may be used during a surveying operation to guide subsequent steps of the surveying operation. In some examples, the system 400 is used to update a survey by using the combination of spectral and spatial information (e.g., from the Lidar spatial output or from a known position and orientation of the spectral Lidar unit 410) to update the model with information of the desirability of material imaged. The survey model may be used to direct the operator of the drilling machine as to where to drill next, used to direct an operator of another mining machine such as an excavator as to where to dig or which material to pick up or where to send the material that is picked up, and/or used to determine or adjust how a blast operation of a body of earthen material is conducted.

A controller 440 controls operations and/or receives information from the spectral Lidar unit 410. In some examples, the controller 440 includes at least one processor 444 and at least one data storage device 446. The at least one data storage device 446 stores a set of computer-executable instructions 448 for operating the at least one processor 444. The computer-executable instructions 448 include instructions for operating the at least one processor 444 to acquire the spectral and spatial data of the material 402 from the return 422 and generating the output signal. The computer executable instructions 448 may include instructions for operating the at least one processor 444 to fly the aircraft 404 over a material of interest to generate the output signal concerning the material of interest. In some examples, the system 400 takes into account lensing needed for different distances. The spectral Lidar unit 410 may include a lensing system 418 operable to change the focal distance for different applications. In some examples, the system 400 includes anti-jiggering measures. The system 400 may include on or more positioning devices 416, such as an inertial measurement unit or global positioning system unit, to provide an accurate position of the spectral Lidar unit 410 for use in making calculations.

An alert device 462 may be provided at the ground level 406. For example, the alert device 462 may be provided adjacent a material transport path 474, such as to a driver of a transport 496, e.g., to direct the driver as to where to go (e.g., which branch 474a, 474b of the transport path 474 to take). For example, the driver may be directed to move the material to one of the highly-desirable area 464 or the undesirable area 466. Alternatively, or additionally, the alert may be provided to an operator of a mining machine 478 (e.g., provided to an alert device in a cab 476 of a mining machine 478), e.g., to direct the operator as to what to do with material that has been picked up by the mining machine 478 or to direct the operator as to which material 402 to pick up using the mining machine 478.

Alternatively, or additionally, the alert may be provided to an operator at a control station 498 (e.g., provided to an alert device in the control station 498). The alert may, e.g., direct the operator of the control station as to how to instruct the operator of a mining machine 478 or transport 496. The alert may, e.g., direct the operator of the control station as to how to adjust the configuration of one or more processing stages 408 of the mining facility 450, such as a primary crusher 408a, a sizing and/or screening facility 408b, a wet milling stage 408c, and/or a drying stage 408d. One or more processing stage 408 may be configured to increase the processing yield for, e.g., the mineral content of the material that is coming, the fragment sizes of the material that is coming, and/or the quantity of material that is coming in order to reduce energy use and water consumption. For example, if the average, mean or largest fragment size of the material that is coming down the processing chain is larger than a previous collection of material, additional crushing may be needed, and vice versa. In some examples, a spectral Lidar imaging system is also, or alternatively, provided at or between processing stages 408.

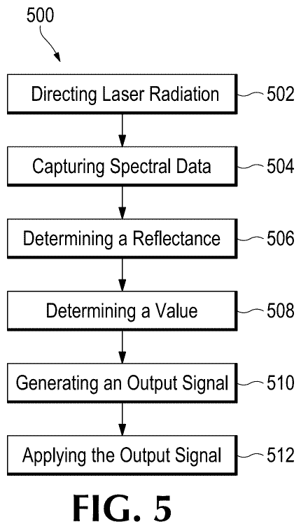

Referring now to FIG. 5, illustrated is an imaging method 500. The imaging method 500 may be a computer-implemented method. The imaging method 500 may be carried out by an imaging system described herein or a part thereof (e.g., a controller of an imaging system described herein).

The method 500 includes, at step 502 directing light towards a material using a spectral Lidar unit. The light includes a plurality of wavelengths. At step 504 the method 500 includes capturing spectral and spatial data. The spectral data includes an intensity of a return of the light from the material for each of a plurality of wavelength bands of interest. The spatial data includes a distance and/or position between the spectral Lidar unit and the material for each data sample.

The method 500 includes, at step 506, determining a reflectance of a pixel, voxel, or detector on a generated image, point cloud, or data array created from the spectral and spatial data of the material using the spectral and spatial data of the material and emission characteristics of the light. Step 506 may include accounting for situational noise (e.g., due to solar radiation).

At step 508 a desirability of the material is determined based on the reflectance, e.g., the reflectance of each pixel, voxel, or detector at a plurality of wavelengths. Step 508 may include comparing the reflectance to that of known valuable materials to determine a likelihood of valuable material. Step 508 may include aggregating the pixel, voxel, and detector values of the potential valuable material to characterize the material and determine a desirability of the material. Step 508 may include, e.g., comparing to a library of information. In some examples, step 508 includes inputting to a machine learned model.

At step 510, an output signal is generated. The output signal indicates a first direction for the earthen material if the desirability of the earthen material is at or above a predetermined threshold level and a second direction different from the first direction if the desirability of the earthen material is below the predetermined threshold level. In some examples, the output signal indicates one of three or more discrete directions, such as by separating desirability by two or more discrete predetermined threshold levels.

At step 512 the output signal is applied. Step 512 may include providing the output signal to an automated system (e.g., including the system 354 of FIG. 3). In some examples, step 512 includes generating an alert (e.g., using an alert device as described herein) and providing the alert to indicate how an automated system or a human operator should respond. The output device of the alert device may include a screen operable to display an icon or graphic (e.g., an arrow) to direct the material. In some examples, the alert may light up a screen in a particular pathway. In an automated system, such as a conveyer system, the alert may communicate to a switch along the conveyer system that guides the material to a different conveyer path (e.g., a different location).

What has been described above is intended to be illustrative of the disclosure and non-limiting and it will be understood by persons skilled in the art that other variants and modifications may be made without departing from the scope of the disclosure as defined in the claims appended hereto. The scope of the claims should not be limited by the preferred examples and examples, but should be given the broadest interpretation consistent with the description as a whole. Features discussed above may be in different combinations than those discussed.

1-30. (canceled)

31. A spectral light detection and ranging (Lidar) imaging system for earthen material, comprising:
a. a spectral Lidar unit directed towards a target location and operable to image the target location containing the earthen material by emitting pulses of light at a plurality of wavelengths from a light source and capturing spatial data and spectral data at the plurality of wavelengths, the spectral data including an intensity of a return of the light from the target location for each of a plurality of wavelength bands; and
b. a controller communicatively coupled to the spectral Lidar unit to control operations of the spectral Lidar unit and receive data from the spectral Lidar unit, the controller including at least one processor and at least one data storage device communicatively coupled to the at least one processor and having stored thereon emission characteristics of the light and computer-executable instructions for operating the at least one processor to:
i. direct the spectral Lidar unit to image earthen material at the target location to generate spatial data and spectral data of the earthen material at each of the plurality of wavelengths,
ii. receive the spatial data and spectral data of the earthen material,
iii. determine a reflectance at the plurality of wavelengths of the earthen material using the spectral data of the earthen material and the emission characteristics of the light,
iv. characterize the earthen material to detect a foreign object or a tramp metal, and
v. generate an output signal, the output signal indicating the foreign object or tramp metal has been detected.

32. The system of claim 31, further comprising an alert device communicatively coupled to the controller to receive the output signal and provide an alert to a human operator based on the output signal.

33. The system of claim 32, wherein the alert device is remote from the spectral Lidar unit.

34. The system of claim 32, wherein the alert is an audible alert or a graphic on a screen.

35. The system of claim 31, wherein the plurality of wavelength bands are selected to correspond to one or more characteristic features of a selected valuable earthen material, various foreign objects, and/or tramp metal.

36. The system of claim 31, wherein the target location is in an opening of a bucket of an excavator and the spectral Lidar unit is mounted to earth moving equipment.

37. The system of claim 36, wherein the output signal indicates to empty the bucket into a first truck or into a second truck different from the first truck.

38. The system of claim 31, wherein the target location is a work surface near an excavator and the spectral Lidar unit is mounted to an excavator.

39. The system of claim 38, wherein the output signal indicates where to apply the bucket of the excavator along an indicated path.

40. The system of claim 31, wherein the target location is above a material transport path, and the spectral Lidar unit is mounted to a support system above the material transport path and directed downward towards the target location.

41. The system of claim 31, further comprising a light source.

42. The system of claim 31, wherein the light source is a supercontinuum laser.

43. The system of claim 37, wherein the light source includes a filter selected to block the emission of all but a predetermined set of wavelengths.

44. The system of claim 41, wherein the spectral Lidar unit includes a unit housing, the unit housing containing the light source, the light source being a laser source operable to generate the light and at least one sensor operable to capture the spectral and spatial data.

45. The system of claim 31, wherein the output signal controls an automated system for a conveyer belt that directs material to a specific location based upon the detection of a foreign object and/or tramp metal.

46. The system of claim 31, wherein detecting the foreign object or tramp metal within the earthen material includes using a machine learned model to recognize foreign objects or tramp metal within the earthen material.

47. The system of claim 31, further comprising a mining drilling machine, wherein the spectral Lidar unit is mounted to the drilling machine and directed towards the target location adjacent the drilling machine.

48. The system of claim 47, wherein the target location contains the earthen material lifted by the drilling machine.

49. The system of claim 47, wherein the target location is a down hole location at a wall of a drill hole formed by the drilling machine.

50. The system of claim 31, further comprising an alert device communicatively coupled to the controller to receive the output signal and provide an alert to a human operator based on the output signal.
